(19) United States
(12) Patent Application Publication
(10) Pub. No.: US 2022/0099442 A1
(43) Pub. Date: Mar. 31, 2022

(54) Surveying System

(71) Applicant: TOPCON Corporation, Itabashi-ku (JP)

(72) Inventor: Taizo Eno, Tokyo-to (JP)

(21) Appl. No.: 17/485,842

(22) Filed: Sep. 27, 2021

(30) Foreign Application Priority Data
Sep. 30, 2020 (JP) 2020-165444

(51) Int. Cl. G01C 15/00; G05D 1/08; G05D 1/10; G06T 7/73; B64C 39/02; H04W 4/80

(52) U.S. Cl. CPC G01C 15/002; G05D 1/085; G05D 1/101; G06T 7/73; B64C 39/024; G06T 2207/10028; B64C 2201/108; B64C 2201/127; B64C 2201/145; B64C 2201/146; H04W 4/80

(57) ABSTRACT

Provided is a surveying system including a flying vehicle system which is configured to includes a flying vehicle, a position measuring instrument configured to measure a position of the flying vehicle, and a remote controller configured to control the flying of the flying vehicle and to wirelessly communicate with the flying vehicle system and the position measuring instrument, in which the flying vehicle includes a track ball configured to have a reference position and a reference direction, a shaft configured to extend downward from the track ball and to support such that the shaft becomes tiltable in an arbitrary direction, an infrared sensor configured to project an infrared light to the track ball, and a control device configured to calculate an attitude of the flying vehicle relative to the reference position and the reference direction of the track ball based on the infrared light reflected by the track ball.

### BACKGROUND OF THE INVENTION

The present invention relates to a surveying system configured to measure a position and an azimuth of a small-sized Unmanned Air Vehicle (UAV).

In recent years, with the advancement of a small-sized UAV (Unmanned Air Vehicle), various types of equipment are mounted on the UAV. And the UAV is remotely operated, or autonomously flown, and a necessary work is performed. For instance, a photogrammetric camera or a laser scanner is mounted on the UAV, and the measurement of a lower side from the sky or the measurement of an inaccessible area is performed.

In a positional measurement of the UAV, a position of the UAV is measured by a surveying instrument such as a total station while tracking a target with retroreflective property provided on the UAV. Alternatively, a GPS is mounted on the UAV, and a position of the UAV is measured using the GPS. It is to be noted that, in case of flying the UAV indoors, GPS signals cannot be received. In this case, the UAV's own position is estimated based on a detection result of an IMU (Inertial Measurement Unit) incorporated in the UAV and the most-recently measured UAV's position.

In case of mounting a laser scanner on the UAV and performing the measurement with the use of the laser scanner, a direction or a tilt of the UAV must be known. However, both in the measurement of a position of the UAV using the total station and in the measurement of a position of the UAV using the GPS, measuring a direction or a tilt of the UAV is likewise difficult.

Therefore, to acquire a direction or a tilt of the UAV, an azimuth meter or a tilt detector must be additionally provided on the UAV. For this reason, there arise problems of an increase in weight and of a complication of a structure of the UAV.

### SUMMARY OF INVENTION

It is an object of the present invention to provide a surveying system which can measure a position and an attitude of a flying vehicle without additionally providing a measuring instrument with respect to the flying vehicle.

To attain the object as described, a surveying system according to the present invention is a surveying system including a flying vehicle system which is configured to perform a remote control and include a flying vehicle, a position measuring instrument configured to measure a position of the flying vehicle, and a remote controller configured to control the flying of the flying vehicle and to wirelessly communicate with the flying vehicle system and the position measuring instrument, wherein the flying vehicle includes a plurality of cameras provided on a peripheral surface thereof, a track ball configured to slidably and rotatably support by the flying vehicle and to have a reference position and a reference direction, a shaft configured to extend downward from the track ball and to support such that the shaft becomes tiltable in an arbitrary direction via the track ball, an infrared sensor configured to project an infrared light to the track ball, and a control device, wherein the control device is configured to calculate an attitude of the flying vehicle with respect to the reference position and the reference direction of the track ball based on the infrared light reflected by the track ball.

Further, in the surveying system according to a preferred embodiment, a plurality of auxiliary propeller units configured to rotate an axis of the shaft as a center are provided on the shaft, and the shaft and the track ball are configured to relatively rotate with respect to the flying vehicle by the auxiliary propeller units.

Further, in the surveying system according to a preferred embodiment, a uniaxial laser scanner is incorporated in the track ball, a recess portion is formed at a position of the track ball facing the shaft, the laser scanner is configured to perform a one-dimensional scan using a distance measuring light via a scanning mirror provided in the recess portion, and the control device is configured to perform a three-dimensional rotational irradiation of the distance measuring light by a cooperation between a rotation of the scanning mirror and a rotation of the track ball and acquire point cloud data by a two-dimensional scan.

Further, in the surveying system according to a preferred embodiment, a uniaxial laser scanner is provided at a lower end of the shaft, the laser scanner is configured to perform a one-dimensional scan using a distance measuring light via a scanning mirror, and the control device is configured to perform a three-dimensional rotational irradiation of the distance measuring light by a cooperation between a rotation of the scanning mirror and a rotation of the track ball and acquire point cloud data by a two-dimensional scan.

Further, in the surveying system according to a preferred embodiment, the position measuring instrument is a total station, an omnidirectional prism is provided on a lower surface of the flying vehicle, the position measuring instrument performs the distance measurement and the angle measurement while tracking the omnidirectional prism, and the remote controller is configured to calculate the point cloud data with reference to the position measuring instrument based on a measurement result of the position measuring instrument and the point cloud data acquired by the laser scanner.

Further, in the surveying system according to a preferred embodiment, the position measuring instrument is a total station, an omnidirectional prism is provided on a lower surface of the laser scanner, the position measuring instrument performs a distance measurement and an angle measurement while tracking the omnidirectional prism, and the remote controller is configured to calculate point cloud data with reference to the position measuring instrument based on a measurement result of the position measuring instrument and the point cloud data acquired by the laser scanner.

Further, in the surveying system according to a preferred embodiment, the position measuring instrument is a GPS device, and the remote controller is configured to calculate point cloud data with reference to the position measuring instrument based on a measurement result of the position measuring instrument and the point cloud data acquired by the laser scanner.

Furthermore, in the surveying system according to a preferred embodiment, the control device is configured to cause the cameras to acquire moving images or continuous images, extract each identical feature points in images adjacent to each other in terms of time, calculate a positional deviation between the feature points, and calculate a tilt angle, an azimuth angle, and a moving amount of the flying vehicle at the time of acquiring a subsequent image with respect to a preceding image based on the positional deviation.

According to the present invention, according to the present invention, there is provided a surveying system including a flying vehicle system which is configured to perform a remote control and include a flying vehicle, a position measuring instrument configured to measure a position of the flying vehicle, and a remote controller configured to control the flying of the flying vehicle and to wirelessly communicate with the flying vehicle system and the position measuring instrument, wherein the flying vehicle includes a plurality of cameras provided on a peripheral surface thereof, a track ball configured to slidably and rotatably support by the flying vehicle and to have a reference position and a reference direction, a shaft configured to extend downward from the track ball and to support such that the shaft becomes tiltable in an arbitrary direction via the track ball, an infrared sensor configured to project an infrared light to the track ball, and a control device, wherein the control device is configured to calculate an attitude of the flying vehicle with respect to the reference position and the reference direction of the track ball based on the infrared light reflected by the track ball. As a result, measuring equipment such as an azimuth meter or a tilt detector do not have to be provided on the flying vehicle, and the flying vehicle can achieve a reduction in weight and in size.

### BRIEF DESCRIPTION OF DRAWINGS

FIG. 1 is a block diagram of a surveying system according to a first embodiment of the present invention.

FIG. 2A and FIG. 2B are longitudinal sectional views of a flying vehicle according to the first embodiment of the present invention.

FIG. 3 is a plan view of the flying vehicle.

FIG. 4 is a block diagram to show a control system of a flying vehicle system.

FIG. 5 is a block diagram to show a control system of a position measuring instrument according to the first embodiment of the present invention.

FIG. 6 is a block diagram to show an outline configuration of a remote controller and a relationship between the flying vehicle system, the position measuring instrument, and the remote controller according to the first embodiment of the present invention.

FIG. 7A and FIG. 7B are explanatory drawings to show flying vehicle camera images acquired by flying vehicle cameras and feature points extracted from the flying vehicle camera images.

FIG. 8 is a longitudinal sectional view of a flying vehicle according to a second embodiment of the present invention.

### DETAILED DESCRIPTION OF THE PREFERRED EMBODIMENTS

A description will be given below on embodiments of the present invention by referring to the attached drawings.

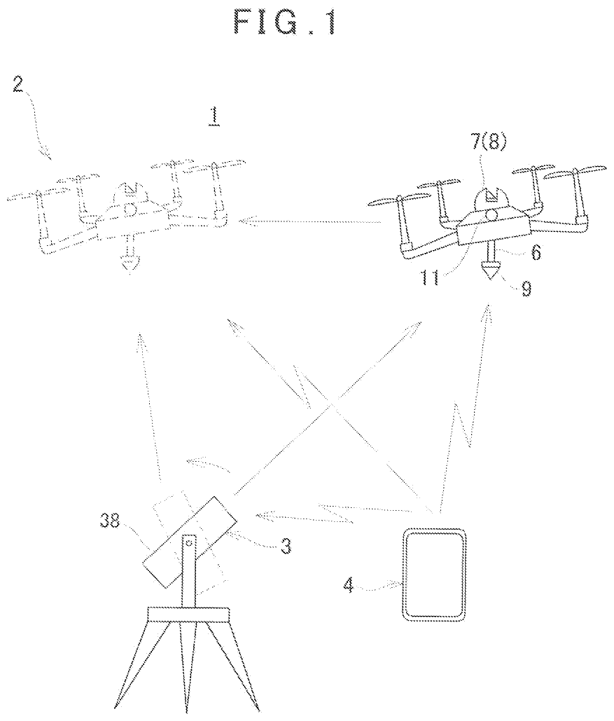

First, in FIG. 1, a description will be given on a surveying system according to a first embodiment of the present invention.

The surveying system 1 mainly includes of a flying vehicle system (a UAV) 2, a position measuring instrument 3 such as a total station (TS) and a remote controller 4.

The flying vehicle system 2 mainly includes a flying vehicle 5, a shaft 6 which is vertically provided so as to pierce through the flying vehicle 5, a track ball 7 which is provided at an upper end of the shaft 6 and supported by the flying vehicle 5, a laser scanner 8 provided to the track ball 7, an omnidirectional prism 9 as a retro-reflector provided at a lower end of the shaft 6, a plurality of (for instance, four) flying vehicle cameras 11 provided on a peripheral surface of the flying vehicle 5, and a flying vehicle communication module 12 (to be described later) which communicates with the remote controller 4. It is to be noted that the laser scanner 8 is integrated with the track ball 7.

It is to be noted that a reference position is set to the flying vehicle 5. The reference position is, for instance, a machine center of the flying vehicle 5, a swing center of the shaft 6, and a center of the track ball 7. Further, an optical center of the laser scanner 8 (a distance measuring light projecting position), an optical center of the omnidirectional prism 9, and the reference position are placed on an axis of the shaft 6, respectively. Further, positional relationships (distances) between the reference position, the optical center of the laser scanner 8, and the optical center of the omnidirectional prism 9 are known, respectively.

The track ball 7 is a spherical object fixed at an upper end of the shaft 6, and can reflect an infrared light on a whole peripheral surface thereof. Further, the track ball 7 has fine dots with different patterns formed on the surface, and a reference position and a reference direction (a zero position and a zero direction) are set. Further, the lower portion of the track ball 7 is accommodated in an upper surface of the flying vehicle 5, and the track ball 7 is slidably and rotatably supported with the flying vehicle 5. Therefore, the track ball 7 functions as a gimbal mechanism configured to maintain the shaft 6 in a vertical attitude.

The shaft 6 is a rod-shaped member which extends downward from the track ball 7, and a weight of the shaft 6 itself and the omnidirectional prism 9 function as a balance weight. Therefore, the vertical attitude of the shaft 6 is maintained via the track ball 7 irrespective of an attitude of the flying vehicle 5. It is to be noted that, if the attitude of the shaft 6 is not stabilized, a balance weight may be additionally provided.

The laser scanner 8 is incorporated in and integrated with the track ball 7. A recess portion 13 is slit-like formed at an upper end portion of the track ball 7, that is, a position facing the shaft 6. A scanning mirror (to be described later) is provided in the recess portion 13, and the scanning mirror is rotatable around a rotation axis orthogonal with respect to an axis of the shaft 6. Further, the laser scanner 8 projects a pulse-emitted or burst-emitted laser beam as a distance measuring light, and irradiates to a predetermined object via the scanning mirror. The distance measuring light reflected by the object (a reflected distance measuring light) is received by the laser scanner 8, and a distance to the object is determined based on a round trip time and a light velocity.

Further, when the scanning mirror is rotated, the distance measuring light passes through the recess portion 13 and is one-dimensionally irradiated within a plane including the axis (a vertical axis) of the shaft 6. It is to be noted that a shape of the recess portion 13 may be a substantially rectangular parallelepiped shape with a bottom surface extending in a direction orthogonal with respect to the axis of the shaft 6. Alternatively, the bottom surface of the recess portion 13 may have a shape tilting downward from the center to the outside such that the distance measuring light is not blocked.

The omnidirectional prism 9 has optical characteristics to retro-reflect a light entering from a lower whole range of the omnidirectional prism 9. It is to be noted that a member having a reflective seal attached to an overall periphery thereof may be provided to a lower surface of the flying vehicle 5 in place of the omnidirectional prism 9.

As regards the flying vehicle cameras 11, field angles, the number, the arrangement, and the like of the respective flying vehicle cameras 11 are determined in such a manner that images of the neighboring flying vehicle cameras 11 overlap each other by a predetermined amount. Further, image pickup optical axes of the respective flying vehicle cameras 11 are set in such a manner that each image pickup axes are orthogonal to a reference position and cross at the reference position of the flying vehicle 5. Further, a relationship between an image pickup center of the flying vehicle camera 11 and the reference position is known.

The position measuring instrument 3 is provided at a position having known three-dimensional coordinates. The position measuring instrument 3 has a tracking function, and measures three-dimensional coordinates of the omnidirectional prism 9 while tracking the omnidirectional prism 9. Further, the position measuring instrument 3 can wirelessly communicate with the remote controller 4, and three-dimensional coordinates measured by the position measuring instrument 3 are input to the remote controller 4 as the coordinate data.

The remote controller 4 is a mobile terminal such as a smartphone or a tablet, or a device having an input device connected to or integrated with the mobile terminal. The remote controller 4 has an arithmetic module having a calculating function, a storage module for storing data or programs, a terminal communication module (to be described later). The remote controller 4 enables the wireless communication with the flying vehicle 2 between the terminal communication module and the flying vehicle communication module 12, and enables the wireless communication with the position measuring instrument 3 between the terminal communication module and a communication module of the position measuring instrument 3. Further, the remote controller 4 remotely operates the flying of the flying vehicle system 2, and can also remotely operate a distance measuring operation performed by the laser scanner 8.

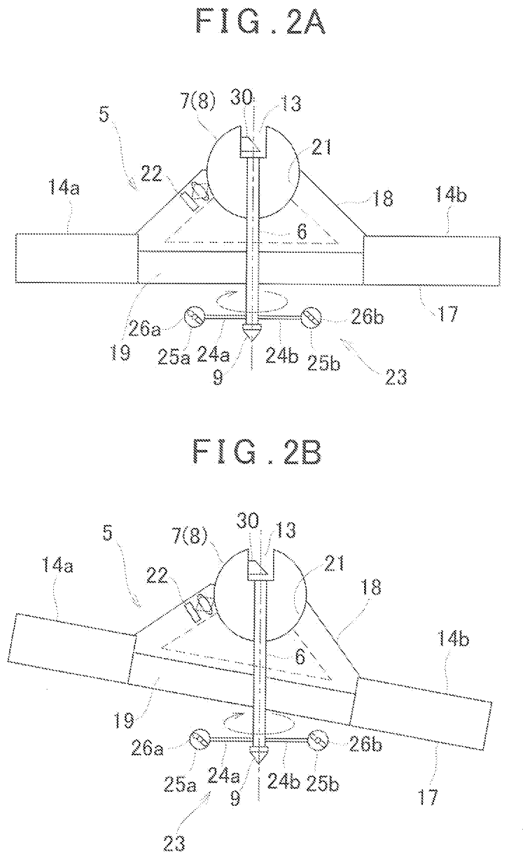

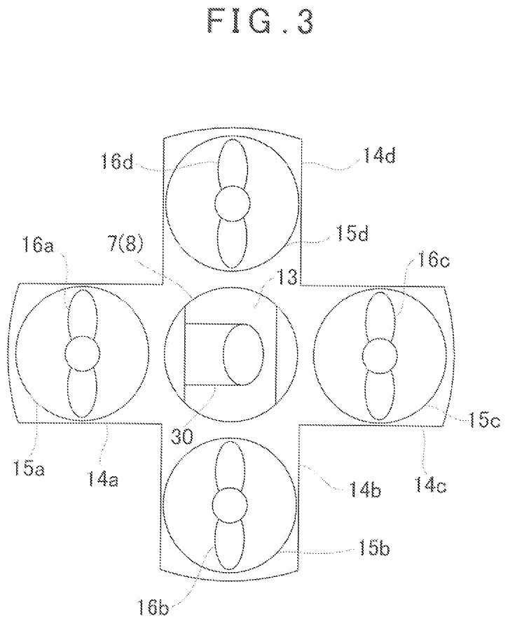

Next, in FIG. 2 and FIG. 3, a description will be given on the flying vehicle system 2.

The flying vehicle 5 has a plurality of and even-numbered propeller frames 14 (in the FIG. 14a to 14d) extending in a radial direction, and propeller unit is provided at a forward end of each of the propeller frames 14. The propeller units are constituted of propeller motors 15 (in the FIG. 15a to 15d) mounted on the forward end of the propeller frames 14, and propellers 16 (in the FIG. 16a to 16d) mounted on an output shaft of the propeller motor 15.

The flying vehicle 5 has a lower frame 17 and an upper frame 18. A penetrating hole 19 is formed longitudinally in a central portion of the lower frame 17, and the shaft 6 is inserted into the hole 19. Further, the propeller frames 14a to 14d extending in a radial direction are provided to the lower frame 17.

Further, the upper frame 18 is formed on an upper surface of the lower frame 17 such that the hole 19 is covered. The upper frame 18 has a hollow truncated conical shape, and an accommodation hole 21 is formed in an upper surface of the upper frame 18.

The accommodation hole 21 is a penetrating hole having a spherical curved surface with the same curvature as the curvature of the track ball 7, and the track ball 7 is rotatably held by the accommodation hole 21. In a state where the track ball 7 is held, the shaft 6 is inserted into the accommodation hole 21, passes through the inside of the upper frame 18, and extends downward via the hole 19. The track ball 7 is stably held in the accommodation hole 21 by a weight of the shaft 6 and the like.

Further, for instance, an infrared sensor 22 which projects an infrared light into, the accommodation hole 21 is incorporated in the upper frame 18. In a state where the track ball 7 is held in the accommodation hole 21, when the infrared sensor 22 detects a reflected light from a predetermined dot of the track ball 7, the infrared sensor 22 can detect an azimuth angle with respect to a reference direction of the flight vehicle 5 and a tilt angle and a tilt direction to the horizontality. Therefore, the infrared sensor 22 and the track ball 7 constitute an attitude detector of the flying vehicle system 2.

The attitude detector can detect a rotation angle (an azimuth angle) of 360° of the flying vehicle 5 in the horizontal direction. Further, the attitude detector can detect a tilt angle of the flying vehicle 5 until the shaft 6 meets an edge of the hole 19 with the track ball 7 as a center.

Further, an auxiliary propeller unit 23 is provided between the omnidirectional prism 9 and the lower frame 17 of the shaft 6. The auxiliary propeller unit 23 is constituted of a plurality of auxiliary propeller frames 24 (in the FIG. 24a, 24b) extending in a radial direction, auxiliary propeller motors 25 (in the FIG. 25a, 25b) mounted on the forward end of the auxiliary propeller frames 24, and auxiliary propellers 26 (in the FIG. 26a, 26b) mounted on an output shaft of the auxiliary propeller motor 25.

Rotation shafts of the auxiliary propellers 26 are orthogonal with respect to axes of the auxiliary propeller frames 24. Therefore, when the auxiliary propeller motors 25 are driven and the auxiliary propeller 26 are rotated, only the shaft 6 horizontally rotates around the axis of the shaft 6. That is, the shaft 6 relatively rotates with respect to the flying vehicle 5 by the auxiliary propellers 26.

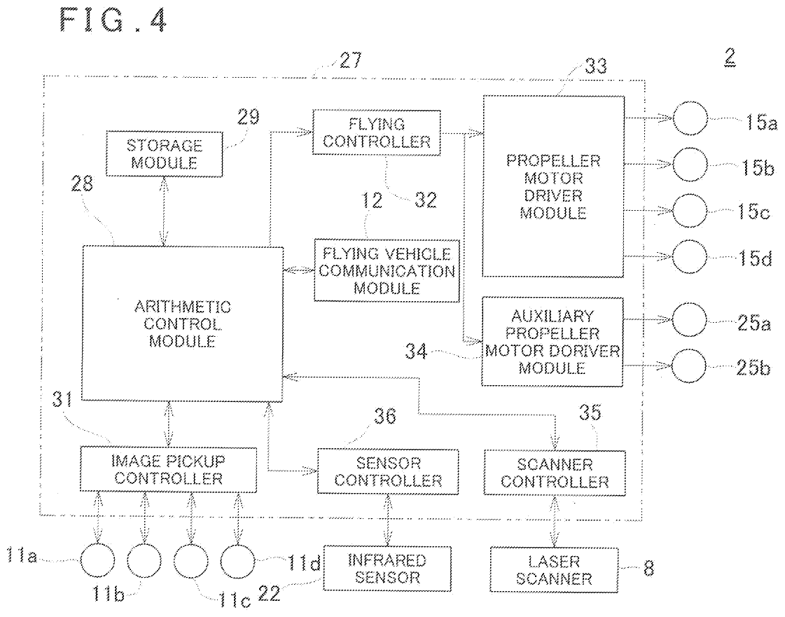

Next, by referring to FIG. 4, a description will be given on a control system of the flying vehicle system 2.

The flying vehicle 5 incorporates a control device 27. The control device 27 mainly includes an arithmetic control module 28, a storage module 29, an image pickup controller 31, a flying controller 32, a propeller motor driver module 33, an auxiliary propeller motor driver module 34, a scanner controller 35, a sensor controller 36, and the flying vehicle communication module 12.

It is to be noted that, in the present embodiment, the scanner controller 35 is included in the control device 27, but the scanner controller 35 and the control device 27 may be separately configured. For instance, the scanner controller 35 may be provided in the laser scanner 8, and control signals may be transmitted or received between the flying vehicle 5 and the laser scanner 8 via the flying vehicle communication module 12.

The photographing of the flying vehicle cameras 11 (in the FIG. 11a to 11d) is controlled by the image pickup controller 31. Images taken by the flying vehicle cameras 11 are input to the image pickup controller 31 as the image data.

As the flying vehicle cameras 11, digital cameras are provided, still images can be taken, and frame images constituting moving images or continuous images can be acquired. Further, as an image pickup element, a CCD or CMOS sensor or the like which is an aggregation of pixels is provided, and a position of each pixel on the image pickup element can be identified. For instance, a position of each pixel is identified by Cartesian coordinates having a point which axes of the flying vehicle cameras 11 pass through as an origin. Each pixel outputs the pixel coordinates together with a light reception signal to the image pickup controller 31.

In the storage module 29, a program storage module and a data storage module are formed. In the program storage module, various types of programs are stored. These programs include: a photographing program for controlling the photographing of the flying vehicle cameras 11, a feature point extraction program for extracting feature points from the image data, a positional deviation calculation program for calculating a positional deviation between the identical feature points in the image data adjacent to each other in terms of time, a flying control program for driving and controlling the propeller motors 15, a distance measurement program for controlling a distance measuring operation performed by the laser scanner 8, an attitude detection program for calculating a tilt, a tilt direction and an azimuth (an attitude) of the flying vehicle 5 based on a detection result of the infrared sensor 22, a communication program for transmitting the acquired data to the remote controller 4 and receive a flight instruction or an imaging instruction from the remote controller 4 and other programs.

In the data storage module, various types of data are stored. These data include: the still image data or the moving image data acquired by the flying vehicle cameras 11, the positional data of the flying vehicle system 2 transmitted from the remote controller 4 which measured by the position measuring instrument 3, a moving distance data and a moving direction data of the flying vehicle system 2 calculated based on a positional deviation between feature points, the tilt angle data and the azimuth angle data of the flying vehicle 5 detected by the attitude detector, times at which the still image data and the moving image data were acquired, the positional data and other data.

The image pickup controller 31 controls the image pickup of the flying vehicle cameras 11a to 11d based on a control signal emitted from the arithmetic control module 28. Further, the flying vehicle cameras 11a to 11d are synchronously controlled by the image pickup controller 31 based on control signals from the remote controller 4 or a projection timing of the distance measuring light emitted from the laser scanner 8 or the like.

The scanner controller 35 controls the driving of the laser scanner 8. That is, the scanner controller 35 controls a light emission interval of the distance measuring light, a rotation speed of a scanning mirror 30 and the like, and performs the rotational irradiation of the distance measuring light via the scanning mirror 30. That is, the scanner controller 35 controls a point cloud interval or the point cloud density of the distance measuring light are irradiated from the laser scanner 8. Further, a light reception result of a reflected distance measuring light is associated with a rotation angle of the scanning mirror 30 and input to the arithmetic control module 28, and the distance measurement is performed.

The sensor controller 36 controls the irradiation and the stop of an infrared light projected from the infrared sensor 22. Further, the infrared light reflected by the track ball 7 accommodated in the accommodation hole 21 is received by the infrared sensor 22, and a light reception signal is output to the sensor controller 36. The sensor controller 36 is configured to determine on which dot on the track ball 7 reflected the infrared light based on the light reception signal. Further, the arithmetic control module 28 calculates a relative tilt and rotation of the track ball 7 with respect to the flying vehicle 5 based on a determination result of the sensor controller 36. That is, the arithmetic control module 28 calculates a tilt and an azimuth of the flying vehicle 5.

It is to be noted that the infrared light may be constantly projected from the infrared sensor 22 or may be projected from the infrared sensor 22 only when the flying vehicle 5 is flying.

In a case where the flying vehicle 5 is remotely operated by the remote controller 4, the flying vehicle communication module 12 receives an operation signal from the remote controller 4 and inputs the operation signal to the arithmetic control module 28. Alternatively, the arithmetic control module 28 has functions to, for instance, associate the respective image data taken by the respective flying vehicle cameras 11 with photographing positions and transmit the image data and the photographing positions to the remote controller 4.

The arithmetic control module 28 performs various types of control for scanning (measuring) an object with the distance measuring light based on various types of programs stored in the storage module 29. Further, the arithmetic control module 28 calculates a control signal concerning the flying based on the operation signal or a positional deviation of feature points between the adjoining image data, and outputs the control signal to the flying controller 32.

Based on the control signals concerning the flying, the flying controller 32 drives the propeller motors 15 to a necessary state via the propeller motor driver module 33, and drives the auxiliary propeller motors 25 to a necessary state via the auxiliary propeller motor driver module 34.

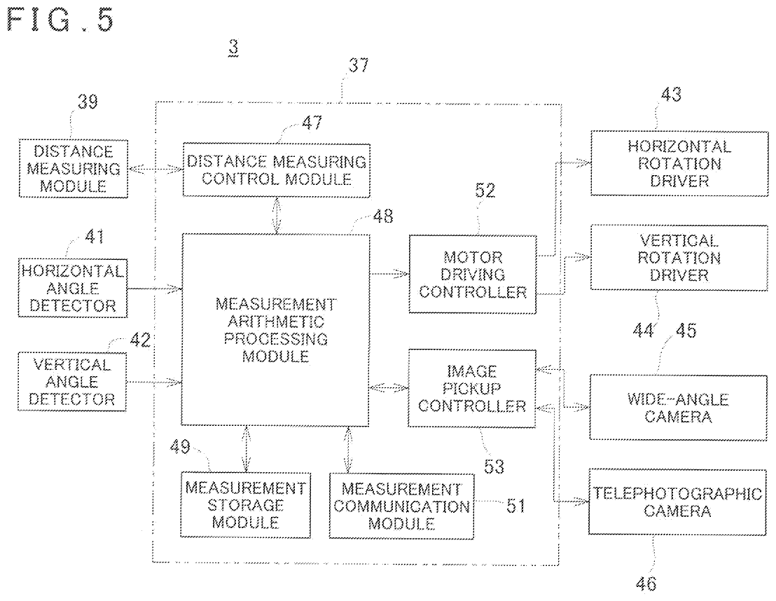

Next, a description will be given on the position measuring instrument 3 by referring to FIG. 5.

The position measuring instrument 3 mainly includes a measurement control device 37, a telescope module 38 (see FIG. 1), a distance measuring module 39, a horizontal angle detector 41, a vertical angle detector 42, a horizontal rotation driver 43, a vertical rotation driver 44, a wide-angle camera 45, a telephotographic camera 46 and the like.

The telescope module 38 is configured to sight an object. The distance measuring module 39 projects the distance measuring light via the telescope module 38, receives a reflected distance measuring light from the object via the telescope module 38, and performs the distance measurement. That is, the distance measuring module 39 has functions as an electronic distance meter. Further, the telescope module 38 has the wide-angle camera 45 and the telephotographic camera 46 incorporated in the telescope module 38. The wide-angle camera 45 has a wide angle of view, for instance, 30°, and the telephotographic camera 46 has a field angle narrower than that of the wide-angle camera 45, which is, for instance, 5°. It is to be noted that an optical axis of the wide-angle camera 45 and an optical axis of the telephotographic camera 46 are parallel with respect to an optical axis of the distance measuring light respectively, and distances between the respective optical axes are known. Alternatively, the optical axis of the wide-angle camera 45 and the optical axis of the telephotographic camera 46 may coincide with the optical axis of the distance measuring light, respectively.

Further, the distance measuring module 39 can track the object (the omnidirectional prism 9) while performing the prism measurement. In case of tracking the object, a tracking light is projected coaxially with the distance measuring light via the telescope module 38. Alternatively, the object may be captured by any one of the wide-angle camera 45 and the telephotographic camera 46, and the horizontal rotation driver 43 and the vertical rotation driver 44 may be controlled in such a manner that the object can be constantly placed on an image center of the camera.

The horizontal angle detector 41 detects a horizontal angle in a sighting direction of the telescope module 38. Further, the vertical angle detector 42 detects a vertical angle in the sighting direction of the telescope module 38. Detection results of the horizontal angle detector 41 and the vertical angle detector 42 are input to the measurement control device 37.

The measurement control device 37 mainly includes a distance measuring control module 47, a measurement arithmetic processing module 48, a measurement storage module 49, a measurement communication module 51, a motor driving controller 52, an image pickup controller 53 and the like.

The distance measuring control module 47 controls a distance measuring operation of the omnidirectional prism 9 by the distance measuring module 39 based on control signals from the measurement arithmetic processing module 48. Further, in the measurement storage module 49, various types of programs are stored. These programs include: a measurement program for performing the distance measurement of the omnidirectional prism 9, a tracking program for tracking the omnidirectional prism 9, an image pickup program for performing the image pickup of the wide-angle camera 45 and the telephotographic camera 46, a communication program for performing the communication with the flying vehicle system 2 and the remote controller 4 and other programs. Further, in the measurement storage module 49, measurement results (a distance measurement result, an angle measurement result) of the omnidirectional prism 9 are stored.

The measurement communication module 51 transmits a measurement result of the omnidirectional prism 9 (a slope distance, a horizontal angle, and a vertical angle of the omnidirectional prism 9) to the remote controller 4 in real time.

To sight the omnidirectional prism 9 or to track the omnidirectional prism 9 by the telescope module 38, the motor driving controller 52 controls the horizontal rotation driver 43 and the vertical rotation driver 44, and rotates the telescope module 38 in the horizontal direction or the vertical direction.

The image pickup controller 53 controls the image pickup of the wide-angle camera 45 and the telephotographic camera 46. It is to be noted that, in a state where the position measuring instrument 3 tracks the omnidirectional prism 9, the flying vehicle 5 is configured to be always placed within an image acquired by the wide-angle camera 45 and the telephotographic camera 46.

The position measuring instrument 3 performs the distance measurement while tracking the omnidirectional prism 9, and measures three-dimensional coordinates of the omnidirectional prism 9 in real time based on a distance measurement result and detection results of the horizontal angle detector 41 and the vertical angle detector 42.

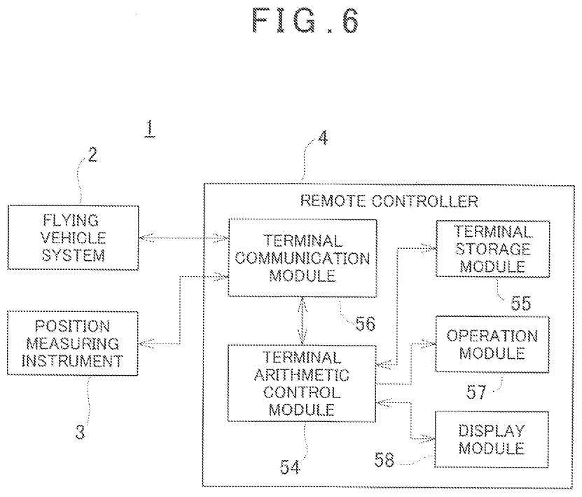

FIG. 6 is a diagram to show an outline configuration of the remote controller 4 and a relationship between the flying vehicle system 2, the position measuring instrument 3 and the remote controller 4.

The remote controller 4 includes a terminal arithmetic processing module 54 having a calculating function, a terminal storage module 55, a terminal communication module 56, an operation module 57 and a display unit 58.

The terminal arithmetic processing module 54 has a clock signal generator, and associates the image data, coordinate data and the like received from the flying vehicle system 2 with clock signals, respectively. Further, the terminal arithmetic processing module 54 processes various types of received data as the time-series data based on the clock signal, and stores the time-series data in the terminal storage module 55.

In the terminal storage module 55, various types of programs are stored. These programs include: a communication program for communicating with the flying vehicle system 2 or the position measuring instrument 3, a calculation program for calculating three-dimensional coordinates of the omnidirectional prism 9 based on three-dimensional coordinates of an installing position of the position measuring instrument 3, a calculation program for calculating three-dimensional coordinates of a measuring point (an object) based on the three-dimensional coordinates of the omnidirectional prism 9, measurement results received from the flying vehicle system 2 or the like, a display program for displaying operation screens, measurement results, images acquired by the respective cameras and the like, or an operation program for inputting instructions via a touch panel or the like.

The terminal communication module 56 performs the communication with the flying vehicle system 2 and with the position measuring instrument 3. Further, the operation module 57 inputs various types of instructions via buttons and the like of a controller integrally provided with the display module 58, and operates the flying vehicle 5.

The display module 58 displays flying vehicle camera images acquired by the flying vehicle cameras 11, wide-angle camera images acquired by the wide-angle camera 45, telephotographic camera images acquired by the telephotographic camera 46, measurement result screens showing measurement results acquired by the position measuring instrument 3 and the like.

It is to be noted that the entire display module 58 may be configured as a touch panel. In a case where the entire display module 58 is a touch panel, the operation module 57 may be omitted. In this case, an operation panel for operating the flying vehicle 5 is provided on the display module 58.

Next, a description will be given on the measurement using the surveying system 1. It is to be noted that the following describes a case where a GNSS device cannot be used indoors, for instance.

First, a reference direction of the track ball 7 is set to a reference azimuth (for instance, north) based on an azimuth meter, or a relative azimuth angle of the reference direction of the track ball 7 with respect to the reference azimuth is calculated. It is to be noted that the azimuth meter may be provided to a device installed at a flying start position of the flying vehicle 5, for instance, the position measuring instrument 3, or may be separately held by a worker. The reference direction of the track ball 7 is set at the flying start position of the flying vehicle 5 based on the azimuth meter. Further, the acquisition of moving images or continuous images is started by the respective flying vehicle cameras 11, and the flying vehicle camera images 59 before the start of flying are acquired.

Next, the flying vehicle 5 is flown via the remote controller 4. At this time, the flying vehicle 5 may be manually operated via the operation panel of the remote operator 4, or the flying vehicle 5 may be automatically flown based on a flying program set in advance.

During the flying of the flying vehicle 5, the shaft 6 is constantly maintained to the verticality by the action of gravity irrespective of an attitude of the flying vehicle 5, and the track ball 7 slides in the accommodation hole 21 with a change in attitude of the flying vehicle 5. Further, during the flying of the flying vehicle 5, the infrared sensor 22 constantly projects an infrared light and receives the infrared light reflected by the track ball 7. The arithmetic control module 28 calculates a relative rotation angle of the flying vehicle 5 and the track ball 7 based on a light reception signal of the infrared sensor 22 received by the sensor controller 36. That is, the arithmetic control module 28 calculates a tilt angle and a tilt direction of the flying vehicle 5. Further, an arithmetic result is constantly transmitted to the remote controller 4 via the flying vehicle communication module 12 and the terminal communication module 56.

On the other hand, the flying vehicle 5 does not have an azimuth meter, the shaft 6 integrally rotates when the flying vehicle 5 rotates, and hence an azimuth of the flying vehicle 5 during the flying cannot be directly detected. In the present embodiment, moving images or continuous images of the whole circumference of 360° are acquired by the flying vehicle cameras 11a to 11d.

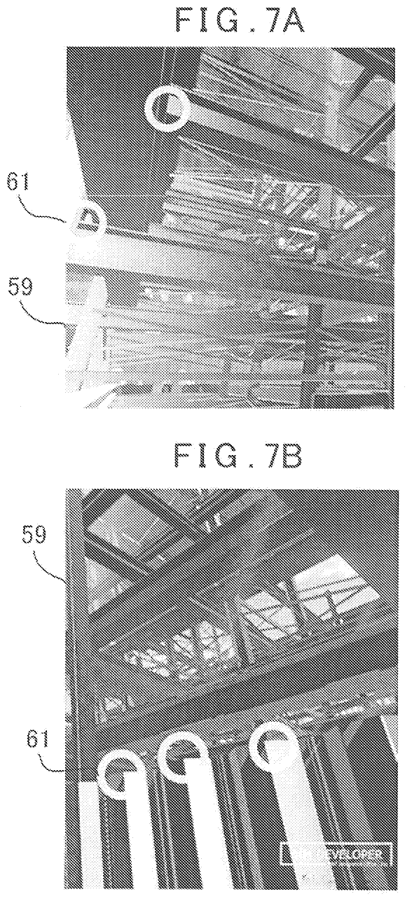

As shown in FIG. 7A and FIG. 7B, during the flying of the flying vehicle 5, the image pickup controller 31 continuously acquires such flying vehicle camera images 59 per each of the flying vehicle cameras 11a to 11d.

The arithmetic control module 28 extracts feature points 61 from corners of a building or steel frames, or a characteristic luminance or the like per each of the flying vehicle camera images 59.

Based on the two flying vehicle camera images 59 which are adjacent to each other in terms of time, the arithmetic control module 28 calculates a positional deviation of the identical feature points 61 in the flying vehicle camera images 59. Further, likewise, regarding to the flying vehicle camera images 59 acquired by the other flying vehicle cameras 11, the arithmetic control module 28 calculates a positional deviation of the feature points 61 in the flying vehicle camera images 59.

A position of each pixel in an image pickup element can be identified. Therefore, for each flying vehicle camera 11, by comparing positions of the feature points 61 in the flying vehicle camera images 59 adjacent to each other in terms of time, the arithmetic control module 28 enables calculating a tilt angle, an azimuth angle, and a moving amount of the flying vehicle 5 at a time point where the subsequent flying vehicle camera image 59 was acquired with respect to a time point where the preceding flying vehicle camera image 59 was acquired.

The calculation of the tilt angle, the azimuth angle, and the moving amount of the flying vehicle 5 are performed in sequence with reference to the flying vehicle camera images 59 acquired before the flying.

It is to be noted that the tilt angle calculated here may be used for correcting a tilt angle calculated based on the infrared light reflected by the track ball 7. Further, during the flying of the flying vehicle 5, a position of the track ball 7 may shift due to the wind or the like, and the track ball 7 may relatively rotate with respect to the flying vehicle 5. In this case, an azimuth angle of the laser scanner 8 can be calculated based on the azimuth angle of the flying vehicle 5 calculated by the flying vehicle camera images 59 and a relative rotation angle of the track ball 7 with respect to the flying vehicle 5.

The arithmetic control module 28 controls an attitude or a flying condition of the flying vehicle 5 based on the sequentially calculated tilt angle, azimuth angle and moving amount of the flying vehicle 5 (an optical flow).

When the flying vehicle 5 approaches a predetermined object, the arithmetic control module 28 performs the measurement processing with respect to the object based on programs stored in the storage module 29. First, the arithmetic control module 28 calculates an attitude of the flying vehicle 5 at the start of the measurement, that is, a tilt angle and a tilt direction based on the infrared light reflected from the track ball 7.

Further, the arithmetic control module 28 rotates the auxiliary propellers 26 such that the distance measuring light is irradiated to the object, drives the scanning mirror 30 of the laser scanner 8, and performs the scanning (scans) the object with the distance measuring light. Further, the arithmetic control module 28 performs the distance measurement in accordance with each of pulsed lights or each of burst lights, and calculates three-dimensional coordinates with reference to a reference position of the flying vehicle 5 based on an attitude of the flying vehicle 5, a rotation angle of the scanning mirror 30 and a distance measuring result. As a result, the point cloud data along a locus of the distance measuring light is acquired.

Further, when the auxiliary propeller motors 25 are driven by the auxiliary propeller motor driver module 34 while performing the rotational irradiation of the distance measuring light and the laser scanner 8 (the track ball 7) is integrally rotated with the shaft 6, the point cloud data of the overall circumference with reference to the reference position of the flying vehicle 5 can be calculated. A rotation angle in the horizontal direction at this time is calculated based on a light reception result of the infrared light reflected by the track ball 7. The calculated point cloud data is transmitted to the remote controller 4 via the flying vehicle communication module 12 and the terminal communication module 56.

It is to be noted that the omnidirectional prism 9 is being tracked by the position measuring instrument 3 even during the measurement carried out by the flying vehicle system 2, and a measurement (the distance measurement, the angle measurement) result of the omnidirectional prism 9 with reference to an installing position of the position measuring instrument 3 is acquired in real time. Further, a measurement result acquired by the position measuring instrument 3 is transmitted to the remote controller 4 via the measurement communication module 51 and the terminal communication module 56.

The terminal arithmetic processing module 54 calculates the point cloud data of an object with reference to the installing position of the position measuring instrument 3 based on a measurement result acquired by the flying vehicle system 2 and a measurement result acquired by the position measuring instrument 3.

If any other object is present, the flying vehicle 5 is again flown to the vicinity of the next object, and the point cloud data of the object is acquired by the same processing as that described above. If any other object is not present, the flying vehicle 5 is collected, and the measurement using the surveying system 1 is finished.

As described above, in the first embodiment, the track ball 7 which is provided at the upper end of the shaft 6 and slidably and rotatably supported by the flying vehicle 5, the shaft 6 as a weight, and the omnidirectional prism 9 function as a gimbal mechanism which configured to maintain a vertical attitude of the shaft 6. Further, the track ball 7 and the infrared sensor 22 provided on the flying vehicle 5 constitute an attitude detector which configured to detect an attitude of the flying vehicle 5.

Therefore, since measuring instruments such as an azimuth meter or a tilt detector do not have to be provided on the flying vehicle 5, a reduction in weight and in size of the flying vehicle 5 can be achieved.

Further, since an azimuth angle of the flying vehicle 5 can be detected by the track ball 7, it is possible to detect a projecting direction (a horizontal angle) of the distance measuring light emitted from the uniaxial laser scanner 8. Therefore, the laser scanner 8 can be provided to the flying vehicle 5 as a measuring instrument which acquires the three-dimensional data, and a distant object can be scanned from close range by the remote control using the laser scanner 8.

Further, since the laser scanner 8 is incorporated in and integrated with the track ball 7, the laser scanner does not have to be additionally provided to the flying vehicle 5 and a reduction in weight and in size of the flying vehicle can be achieved.

Further, when the auxiliary propeller motors 25 are driven, since the shaft 6 and the track ball 7 can be relatively rotated in the horizontal direction with respect to the flying vehicle 5, by cooperating between the vertical rotation of the scanning mirror 30 and the horizontal rotation of the track ball 7, the flying vehicle system 2 enables the irradiation of the distance measuring light in an arbitrary direction. Therefore, even in case of acquiring the point cloud data in a three-dimensional range, since mounting the uniaxial laser scanner on the flying vehicle 5 can suffice, a reduction in weight and in manufacturing cost can be achieved.

Further, during the flying, based on the flying vehicle camera images 59 by the plurality of flying vehicle cameras 11 provided to the flying vehicle 5, it is possible to calculate a relative moving amount, a relative azimuth angle, and a relative tilt angle between the flying vehicle camera images 59 which are adjacent to each other in terms of time. Therefore, the attitude control during the flying, the crash avoidance with respect to obstacles and the like can be performed, and the flight stability can be improved.

It is to be noted that, in the first embodiment, the four flying vehicle cameras 11a to 11d are provided on the peripheral surface of the flying vehicle 5, but a flying vehicle camera which can image pickup the track ball 7 (the recess portion 13 and the scanning mirror 30) may be further added on the upper surface of the flying vehicle 5. By adding the flying vehicle camera, the arithmetic control module 28 enables calculating a relative rotation angle of the track ball 7 with respect to the flying vehicle 5 by the image processing.

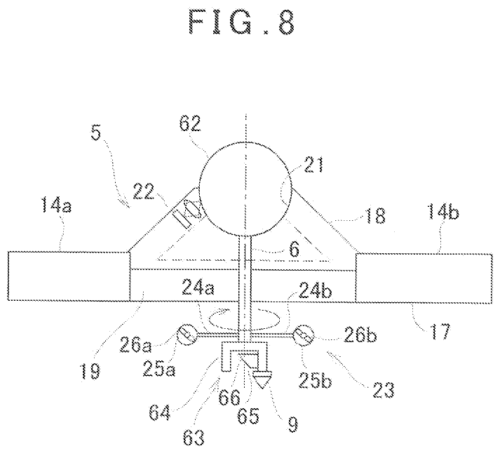

Next, by referring to FIG. 8, a description will be given on a second embodiment of the present invention. It is to be noted that, in FIG. 8, the same components as shown in FIG. 2A and FIG. 2B are referred by the same symbols, and the detailed description thereof will be omitted.

In the first embodiment, the laser scanner is incorporated in the track ball, and the laser scanner and the track ball are integrated. On the other hand, in the second embodiment, a laser scanner is additionally provided to the track ball.

A track ball 62 is provided at an upper end of a shaft 6. Further, a laser scanner 63 is provided at a lower end of the shaft 6. The laser scanner 63 has an inverted U-shaped frame 64 having an opened lower end, and a scanning mirror 66 provided in a recess portion 65 formed in the frame 64. The scanning mirror 66 is rotatable around a rotation axis orthogonal with respect to an axis of the shaft 6.

Further, an omnidirectional prism 9 is provided on a lower surface of one side frame (a lower surface of a right-side frame in the figure) of the frame 64. It is to be noted that a positional relationship (a distance measuring light projecting position) between an optical center of the laser scanner 63 and an optical center of the omnidirectional prism 9 is known. Other structures are the same as the structures in the first embodiment.

In the second embodiment, likewise, since the track ball 62, the shaft 6, the laser scanner 63 and the omnidirectional prism 9 function as a gimbal structure, the shaft 6 is constantly maintained in a vertical attitude. Further, when the flying vehicle 5 has tilted, an arithmetic control module 28 (see FIG. 4) calculates a relative rotation angle of the track ball 62 with respect to the flying vehicle 5, that is, a tilt angle and a tilt direction with respect to the horizontality based on an infrared light reflected by the track ball 62.

Further, when the flying vehicle 5 has approached an object, by rotating the scanning mirror 66 and by integrally rotating the laser scanner 63 with the shaft 6 by auxiliary propellers 26a and 26b, a flying vehicle system 2 (an arithmetic control module 28) can calculate the point cloud data of the overall circumference with reference to a reference position of the flying vehicle 5. Further, when the measurement is performed while tracking the omnidirectional prism 9 by a position measuring instrument 3 (see FIG. 1), the point cloud data of the object with reference to an installing position of the position measuring instrument 3 can be acquired by the position measuring instrument 3 (a measurement control device 37).

In the second embodiment, the laser scanner 63 is provided at a lower end of the shaft 6 as a member different from the track ball 62. Therefore, since the laser scanner 63 also functions as a balance weight of the gimbal mechanism, the stability of an attitude of the shaft 6 can be improved.

It is to be noted that, in the second embodiment, a flying vehicle camera which can image pickup the laser scanner 63 may be further added on a lower surface of the flying vehicle 5. By adding the flying vehicle camera, the arithmetic control module 28 enables calculating a relative rotation angle of the track ball 63 with respect to the flying vehicle 5 by the image processing.

Further, an atmospheric pressure sensor may be provided to the flying vehicle 5. Since an altitude of the flying vehicle 5 can be detected by the atmospheric pressure sensor, the hovering of the flying vehicle 5 is enabled, and the stability of the flying control can be improved.

It is to be noted that, in the first embodiment and the second embodiment, the position measuring instrument 3 is installed at a known position, the omnidirectional prism 9 is provided on the flying vehicle 5, and a position of the flying vehicle 5 is measured while tracking the omnidirectional prism 9 by the position measuring instrument 3, but the embodiments of the present invention are not restricted to the configuration of the above embodiments. For instance, in case of using the flying vehicle system 2 outdoors, a GNSS device as a position measuring instrument may be provided to the flying vehicle 5, and a position of the flying vehicle 5 may be measured by the GNSS device. In case of using the GNSS device, the flying control is performed based on a position detected by the GNSS device.

Further, in the first embodiment and the second embodiment, a total station is used as the position measuring instrument 3, but the position measuring instrument is not restricted to the total station. A device which can track an object and measure a position, for instance, a laser scanner or a tracker can be also used as the position measuring instrument.

Further, in the first embodiment and the second embodiment, the uniaxial laser scanner is used, but the measuring instrument is not restricted to the uniaxial laser scanner. For instance, a biaxial laser scanner may be used, and a scan may be performed in two axial directions. Alternatively, it is possible to adopt a configuration which performs a scan using a distance measuring light in one axial direction or two axial directions by various deflecting means such as a Galvano mirror, a biaxial MEMS mirror, an optical phased array, liquid crystal beam steering or a Risley prism.

1. A surveying system comprising: a flying vehicle system which is configured to perform a remote control and include a flying vehicle, a position measuring instrument configured to measure a position of said flying vehicle, and a remote controller configured to control a flying of said flying vehicle and to wirelessly communicate with said flying vehicle system and said position measuring instrument, wherein said flying vehicle includes a plurality of cameras provided on a peripheral surface thereof, a track ball configured to slidably and rotatably support by said flying vehicle and to have a reference position and a reference direction, a shaft configured to extend downward from said track ball and to support such that said shaft becomes tiltable in an arbitrary direction via said track ball, an infrared sensor configured to project an infrared light to said track ball, and a control device, wherein said control device is configured to calculate an attitude of said flying vehicle with respect to said reference position and said reference direction of said track ball based on said infrared light reflected by said track ball.

2. The surveying system according to claim 1, wherein a plurality of auxiliary propeller units configured to rotate an axis of said shaft as a center are provided on said shaft, and said shaft and said track ball are configured to relatively rotate with respect to said flying vehicle by said auxiliary propeller units.

3. The surveying system according to claim 1, wherein a uniaxial laser scanner is incorporated in said track ball, a recess portion is formed at a position of said track ball facing said shaft, said laser scanner is configured to perform a one-dimensional scan using a distance measuring light via a scanning mirror provided in said recess portion, and said control device is configured to perform a three-dimensional rotational irradiation of said distance measuring light by a cooperation between a rotation of said scanning mirror and a rotation of said track ball and acquire point cloud data by a two-dimensional scan.

4. The surveying system according to claim 1, wherein a uniaxial laser scanner is provided at a lower end of said shaft, said laser scanner is configured to perform a one-dimensional scan using a distance measuring light via a scanning mirror, and said control device is configured to perform a three-dimensional rotational irradiation of said distance measuring light by a cooperation between a rotation of said scanning mirror and a rotation of said track ball and acquire point cloud data by a two-dimensional scan.

5. The surveying system according to claim 3, wherein said position measuring instrument is a total station, an omnidirectional prism is provided on a lower surface of said flying vehicle, said position measuring instrument performs a distance measurement and an angle measurement while tracking said omnidirectional prism, and said remote controller is configured to calculate point cloud data with reference to said position measuring instrument based on a measurement result of said position measuring instrument and said point cloud data acquired by said laser scanner.

6. The surveying system according to claim 4, wherein said position measuring instrument is a total station, an omnidirectional prism is provided on a lower surface of said laser scanner, said position measuring instrument performs a distance measurement and an angle measurement while tracking said omnidirectional prism, and said remote controller is configured to calculate point cloud data with reference to said position measuring instrument based on a measurement result of said position measuring instrument and said point cloud data acquired by said laser scanner.

7. The surveying system according to claim 3, wherein said position measuring instrument is a GPS device, and said remote controller is configured to calculate point cloud data with reference to said position measuring instrument based on a measurement result of said position measuring instrument and said point cloud data acquired by said laser scanner.

8. The surveying instrument according to claim 1, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

9. The surveying system according to claim 2, wherein a uniaxial laser scanner is incorporated in said track ball, a recess portion is formed at a position of said track ball facing said shaft, said laser scanner is configured to perform a one-dimensional scan using a distance measuring light via a scanning mirror provided in said recess portion, and said control device is configured to perform a three-dimensional rotational irradiation of said distance measuring light by a cooperation between a rotation of said scanning mirror and a rotation of said track ball and acquire point cloud data by a two-dimensional scan.

10. The surveying system according to claim 2, wherein a uniaxial laser scanner is provided at a lower end of said shaft, said laser scanner is configured to perform a one-dimensional scan using a distance measuring light via a scanning mirror, and said control device is configured to perform a three-dimensional rotational irradiation of said distance measuring light by a cooperation between a rotation of said scanning mirror and a rotation of said track ball and acquire point cloud data by a two-dimensional scan.

11. The surveying system according to claim 9, wherein said position measuring instrument is a total station, an omnidirectional prism is provided on a lower surface of said flying vehicle, said position measuring instrument performs a distance measurement and an angle measurement while tracking said omnidirectional prism, and said remote controller is configured to calculate point cloud data with reference to said position measuring instrument based on a measurement result of said position measuring instrument and said point cloud data acquired by said laser scanner.

12. The surveying system according to claim 10, wherein said position measuring instrument is a total station, an omnidirectional prism is provided on a lower surface of said laser scanner, said position measuring instrument performs a distance measurement and an angle measurement while tracking said omnidirectional prism, and said remote controller is configured to calculate point cloud data with reference to said position measuring instrument based on a measurement result of said position measuring instrument and said point cloud data acquired by said laser scanner.

13. The surveying system according to claim 9, wherein said position measuring instrument is a GPS device, and said remote controller is configured to calculate point cloud data with reference to said position measuring instrument based on a measurement result of said position measuring instrument and said point cloud data acquired by said laser scanner.

14. The surveying instrument according to claim 2, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

15. The surveying instrument according to claim 3, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

16. The surveying instrument according to claim 4, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

17. The surveying instrument according to claim 5, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

18. The surveying instrument according to claim 6, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

19. The surveying instrument according to claim 7, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.

20. The surveying instrument according to claim 9, wherein said control device is configured to cause said cameras to acquire moving images or continuous images, extract each identical feature points in images adjacent to each other in terms of time, calculate a positional deviation between said feature points, and calculate a tilt angle, an azimuth angle, and a moving amount of said flying vehicle at a time of acquiring a subsequent image with respect to a preceding image based on said positional deviation.
